(19) United States
(12) Patent Application Publication
(10) Pub. No.: US 2021/0290991 A1
(43) Pub. Date: Sep. 23, 2021

(54) STRAPLESS PROTECTIVE MASK

(71) Applicants: Arash MOZAYAN-ISFAHANI, Encinitas, CA (US); Ehsan MOZAYAN-ISFAHANI, Encinitas, CA (US)

(72) Inventors: Arash MOZAYAN-ISFAHANI, Encinitas, CA (US); Ehsan MOZAYAN-ISFAHANI, Encinitas, CA (US)

(21) Appl. No.: 16/903,091

(22) Filed: Jun. 16, 2020

Related U.S. Application Data
(60) Provisional application No. 62/992,796, filed on Mar. 20, 2020.

(51) Int. Cl. A62B 18/02; A62B 18/08; A62B 23/02; A41D 13/11; B29C 65/54; B29C 65/72; B29C 65/00; B32B 7/12; B32B 7/06; B32B 5/02; B32B 27/12; B32B 27/40; B32B 37/12

(52) U.S. Cl. CPC A62B 18/025; B29L 2031/14; A62B 23/025; A41D 13/1176; B29C 65/54; B29C 65/72; B29C 66/02241; B32B 7/12; B32B 7/06; B32B 5/022; B32B 5/024; B32B 27/12; B32B 27/40; B32B 37/1207; A41D 13/1184; A62B 18/084

(57) ABSTRACT

A personalize disposable self-adhesive and strapless protective mask for preventing inhalation of airborne materials, bacteria and viruses is provided. The self-adhesive protective mask includes a pliable adhesive film that is configured to surround a wearer's nose and mouth and a filtering material disposed at a central area for filtering air. A removable carrier is disposed along at least a portion of the perimeter of the adhesive film that is configured to facilitate handling and positioning of the protective mask onto a wearer's nose and mouth.

### CROSS-REFERENCE TO RELATED APPLICATIONS

This application claims the benefit of U.S. Application No. 62/992,796 filed Mar. 20, 2020, entitled “DISPOSABLE SELF-ADHESIVE AND STRAPLESS PROTECTIVE MASK”, which is incorporated by reference in its entirety.

### FIELD

The present invention generally relates to a protective mask, and more particularly to a personalized, self-adhesive, and strapless protective mask for preventing inhalation of airborne materials, bacteria, and viruses.

### BACKGROUND

Disposable and non-disposable protective masks may be used in the medical field to prevent contamination and resulting infection of patients as well as health care personnel by airborne pathogens. Therefore, it has become necessary to both prevent the spread of infections from patients to health care personnel as well as prevent the spread of infections from health care personnel to patients by inhalation of airborne infectious aerosols and/or particulate matter, or by contamination of a wound or surgical incision by airborne infectious aerosols and/or particulate matter. Conventional protective masks may require complex manufacturing processes and access to materials (e.g., different components of a filtering material, straps, etc.) that may render manufacture and access to such masks difficult during a time of crisis. Specifically, access to protective equipment, including face masks, may be limited where unforeseen demand, such as a global epidemic, exhausts supply where it is necessary to prevent aerosols and/or particulate matter from a person's nose and mouth, and so forth, from contacting others, to prevent the spread of disease(s). Additionally, conventional protective masks may not provide a sufficient seal against the wearer's skin to prevent undesired particulates, viruses, and/or bacteria from reaching the nose and/or mouth of the wearer.

### SUMMARY

According to various aspects of the subject technology, a self-adhesive and strapless protective mask is provided. The self-adhesive protective mask includes a pliable adhesive film that is configured to surround a wearer's nose and mouth and a filtering material disposed at a central area for filtering air. The mask and/or filtering material may be constructed for reusability, or may be designed to be single-use (disposable) depending on the desired implementation. A removable carrier is provided along at least portions of the perimeter of the adhesive film to facilitate handling and positioning of the protective mask onto a wearer's nose and mouth. In at least one example, the removable carrier is disposed on an opposing side of an adhesive of the adhesive film, for example, to facilitate handling and positioning of the protective mask onto the wearer's face.

In other examples, the removable carrier can be disposed on the same side of the adhesive of the adhesive film such that the removable carrier covers a portion of the adhesive. The removable carrier assists the pliable adhesive film in maintaining its shape to prevent the adhesive film from adhering to itself before being applied to the wearer's skin. The removable carrier can be removed after at least a portion of the adhesive film is adhered to the wearer's skin so that the adhesive film can better conform to the wearer's face. In one aspect, the adhesive film is pliable to enable a wearer to adequately move their mouth and lips to communicate with others. In another aspect, the adhesion between the wearer's skin and the adhesive film creates a seal to prevent airborne materials, bacteria, and viruses from coming into contact with the wearer's nose or mouth. The adhesive film may be constructed of any of a variety (or combination) of materials, including but not limited to a polymer, an elastomer, or elastomer based composite materials, etc.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates a front view of a self-adhesive protective mask, in accordance with various aspects of the subject technology.

FIG. 2 illustrates a rear view of a self-adhesive protective mask, in accordance with various aspects of the subject technology.

FIG. 3 illustrates a user wearing a self-adhesive protective mask, in accordance with various aspects of the subject technology.

FIG. 4 illustrates an example of a self-adhesive mask having a removable filter according to some aspects of the disclosed technology.

FIGS. 5A and 5B illustrate examples of a self-adhesive mask having a filter partial-circumferential adhesion, according to some aspects of the disclosed technology.

FIG. 6 illustrates an example of a self-adhesive mask having an opening tab, according to some aspects of the disclosed technology.

FIG. 7 illustrates an example of a self-adhesive mask having a valve, according to some aspects of the disclosed technology.

FIG. 8 illustrates an example of a full-face self-adhesive mask, according to some aspects of the disclosed technology.

FIGS. 9A and 9B illustrate examples of self-adhesive masks with different filter patterns, according to some aspects of the disclosed technology.

FIG. 9C illustrates an example perspective view of a mask disposed on a wearer's face, according to some aspects of the disclosed technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

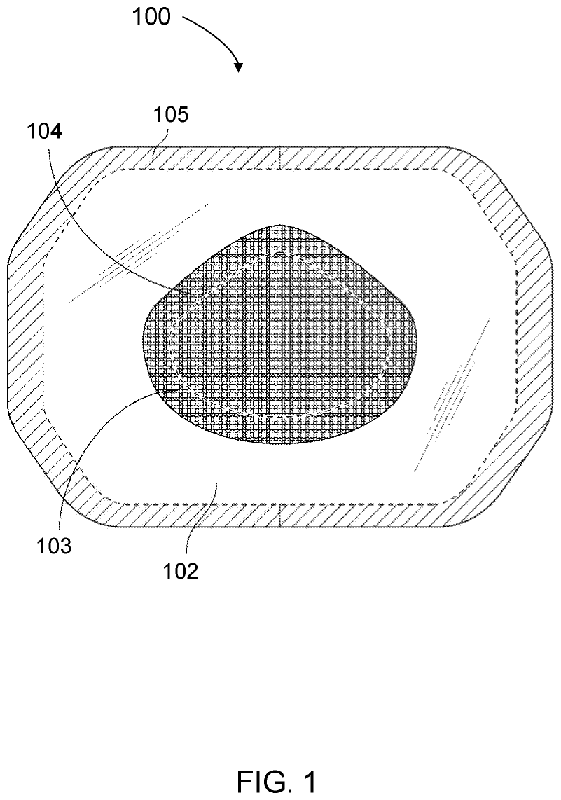

FIG. 1 illustrates a front view of a self-adhesive protective mask 100, in accordance with various aspects of the subject technology. The protective mask 100 comprises a self-adhesive mask that is secure and comfortable to wearer, and easily manufactured due to its minimal use of materials and reduction in required manufacturing processes. The protective mask 100 comprises an adhesive film 102 having a central opening 103. The opening 103 is thus surrounded by the adhesive film 102. The opening 103 may be of any shape that enables a user or wearer to adequately breath and speak, as desired. In one aspect, the opening 103 may have differing shapes and sizes, depending on a size, age or gender of a user. The adhesive film 102 may comprise a thin polymer material, such as a polyurethane membrane, that is coated with a layer of an adhesive, such as an acrylic adhesive, configured to bond to skin, while also enabling removal when desired. However, it is understood that other materials may be used for the adhesive film and/or adhesive, without departing from the scope of the disclosed technology. The adhesive film 102 can be biocompatible such that the adhesive film 102 does not harm the user's skin, for example creating rashes or allergic reactions. The adhesive film 102 can then be worn for longer periods of time without issue. The adhesive film 102 is impermeable to micro-organisms (e.g., bacteria, viruses, etc.) to thereby provide an effective barrier to external contamination.

A filtering material 104 is disposed over the opening 103 of the adhesive film 102 to filter out undesired particulates and airborne materials to prevent their inhalation by the wearer. Various air permeable fabrics, woven and non-woven, having the desired filtration properties may be used. For example, the filtering material 104 may be desirably constructed of a light-weight, softened, and non-irritating, woven or non-woven fabric that is configured to inhibit the passage of airborne bacteria or viruses in either direction, which prevent passage of germs to and from the wearer. In one aspect, because the filtering material 104 is utilized with a pliable and flexible adhesive film 102, the filtering material may be formed of a concise amount of material without regard to accommodating typical mouth and lip movement, as is done with conventional masks that utilize excess material around a wearer's mouth. As such, materials are efficiently utilized, without waste, lending to a reduction in cost and ease in manufacturability.

In one aspect, the filtering material 104 may be directly or indirectly coupled to the adhesive film 102. For example, filtering material 104 may be directly adhered to adhesive film 102. In another example, the filtering material 104 may be coupled to the adhesive film 102 via an intermediate membrane that may, for example, surround the filtering material 104 to enable the filtering material 104 to move independently with respect to the adhesive film 102 to provide the wearer with greater flexibility in moving their mouths and/or lips.

Bonding between filtering material 104 and adhesive film 102 can be performed in various ways depending on the desired implementation. For example, via an adhesive bond between the filtering material 104 and film 102, or by using a heated bonding process, etc. It is understood that other bonding methods are contemplated, without departing from the scope of the disclosed technology. Additionally, filtering material 104 may be bonded to either side of adhesive film 102; that is, filtering material may be bonded on an interior surface of adhesive film 102 that contacts the wearer's face, or to an outside surface, depending on the desired implementation.

A carrier 105 can be disposed on at least a portion of a perimeter of the adhesive film 102, or alternative on an entire surface of the adhesive film. The carrier 105 is configured to enable the wearer to easily handle and manipulate the protective mask 100 as the wearer places the protective mask 100 over their nose and mouth. In some aspects, the carrier 105 is sufficiently rigid to maintain a shape of the protective mask 100 after a liner (not shown) is removed from an interior surface of the adhesive film 102 to expose an adhesive layer of the adhesive film 102. In one aspect, the carrier 105 is disposed on a first surface of the adhesive film 102 (e.g., an exterior surface), and the liner is disposed on an opposing second surface (e.g., an interior surface) of the adhesive film 102. In other aspects, the carrier 105 is disposed on adhesive film 102 such that a portion of the adhesive is covered.

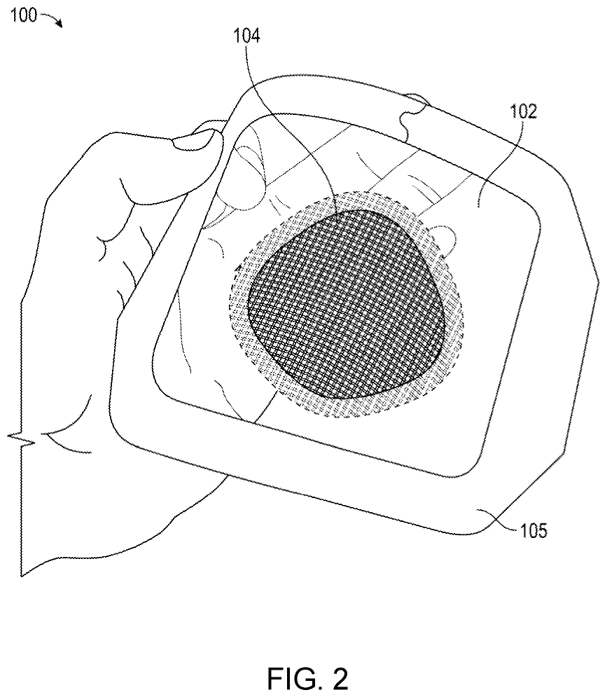

FIG. 2 illustrates a rear view of the self-adhesive protective mask 100, in accordance with various aspects of the subject technology. A liner (not shown) may be disposed over the adhesive film 102 to prevent accidental adhesion of the adhesive film 102 prior to application. After a user removes the liner, the adhesive layer of the adhesive film 102 is exposed. Once exposed, the protective mask 100 is ready for application over a wearer's nose and mouth. The carrier 105 (disposed opposite the adhesive layer) maintains the shape of the protective mask 100 during application and provides the user with a means to handle the protective mask 100. In another aspect, the carrier 105 prevents folding or crinkling of the adhesive layer 102 during application to ensure a proper seal onto a wearer's skin During application, a user may center the protective mask 100 over their nose and/or mouth to ensure that the filtering material 104 adequately covers their nose and/or mouth. Once properly located, the wearer may affix the protective mask 100 onto the skin surrounding their mouth and/or nose. In one aspect, to ensure a proper seal is created between the adhesive film 102 and skin, the adhesive film 102 may be sized to extend over at least portions of the wearer's cheek, bridge of their nose, and/or chin. Once applied, the wearer may remove the carrier 105 by peeling the carrier 105 away from the adhesive film 102.

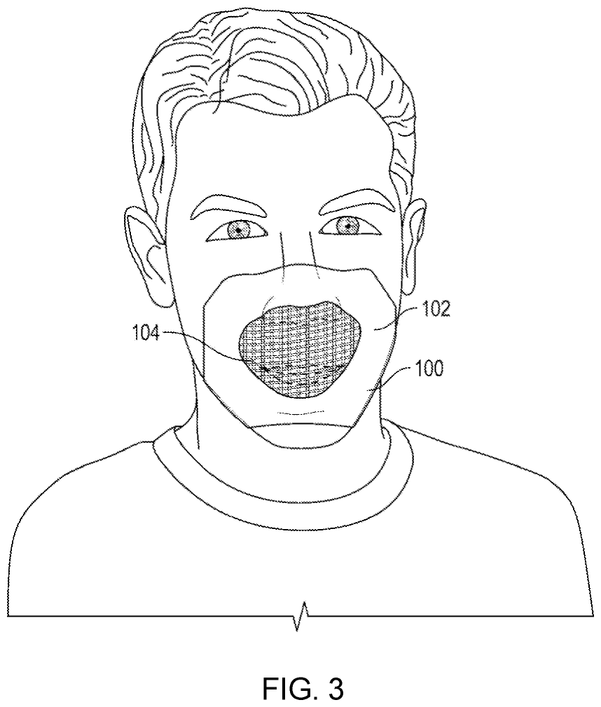

FIG. 3 illustrates a user wearing the self-adhesive protective mask 100, in accordance with various aspects of the subject technology. The adhesive film 102 creates a seal between the wearer's skin and the protective mask 100 to prevent inhalation or exposure to airborne materials, bacteria, and/or viruses. In one aspect, the adhesive film 102 is sufficiently pliable to enable a wearer to move their lips and mouth to adequately communicate with others, without compromising the seal.

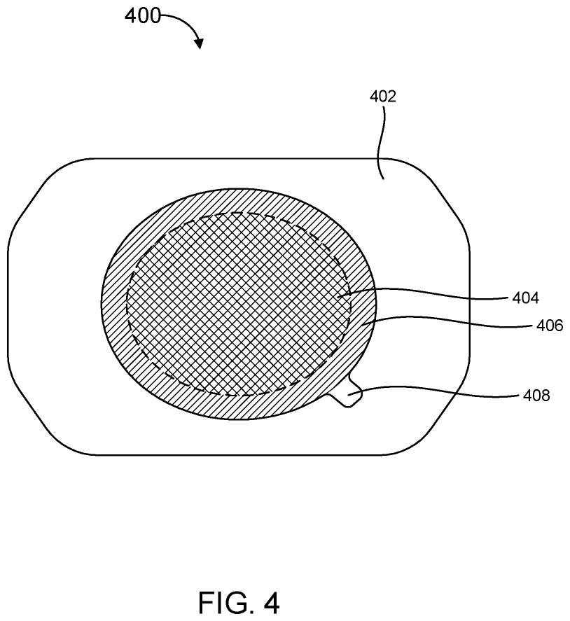

FIG. 4 illustrates an example of a self-adhesive mask 400 having a removable filter 404 according to some aspects of the disclosed technology. Mask 400 includes an adhesive film 402 that is configured to be attached to a removable filter 404. Depending on the desired implementation, the removable filter 404 adhesive film may be attached to an interior or exterior surface of adhesive film 402. In the illustrated configuration, removable filter 404 is affixed to adhesive film 402 via a peripheral adhesive layer 406. In some aspects, removable filter 404 can be removed from adhesive film 402, for example, by applying force to tab 408. In this manner, removable filter 404 can be removed when the wearer wishes to engage in some activity without the filter 404, such as eating or drinking. In some implementations, removable filter 404 can be re-affixed to adhesive film 404 without degradation in the overall efficacy of self-adhesive mask 400.

In some implementations, tab 408 may be configured to be tucked away beneath adhesive film 402. Additionally, in some embodiments, removable filter 404 can be configured for reuse, while the adhesive film 402 may be disposable. In this manner, the user/wearer may remove filter 404 using tab 408, and replace the adhesive film when the mask 400 is reapplied. By way of example, a liner (not illustrated) covering adhesive film 402 can be removed before the reusable/removable filter 404 is attached to the adhesive film 402 and once a seal is created, the mask can be placed onto the wearer's face.

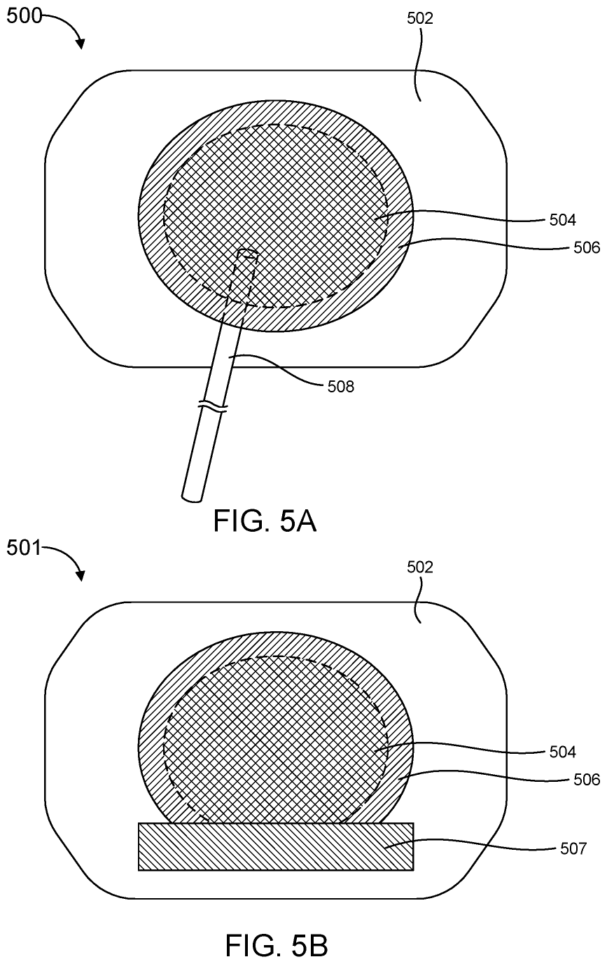

FIGS. 5A and 5B illustrate examples of a self-adhesive mask having a filter 504 with a partial-circumferential adhesion 506, according to some aspects of the disclosed technology. In particular, FIG. 5A illustrates a self-adhesive mask configuration 500 in which a filter 504 is affixed to adhesive film 502 via a partially circumferential adhesive 506. As such, filter 504 is configured to permit passage of objects (e.g. a straw 508) through an opening wherein an adhesive bond is not formed between filter 504 and film 502.

FIG. 5B illustrates a self-adhesive mask configuration 501 in which the entire periphery of filter 504 is secured to film 502. In this example, an adhesive patch 507 (e.g., an adhesive tape) is used to secure the opening illustrated in FIG. 5A. It is understood that the adhesive patch may have different shapes or may utilize different adhesive strengths, depending on the desired implementation.

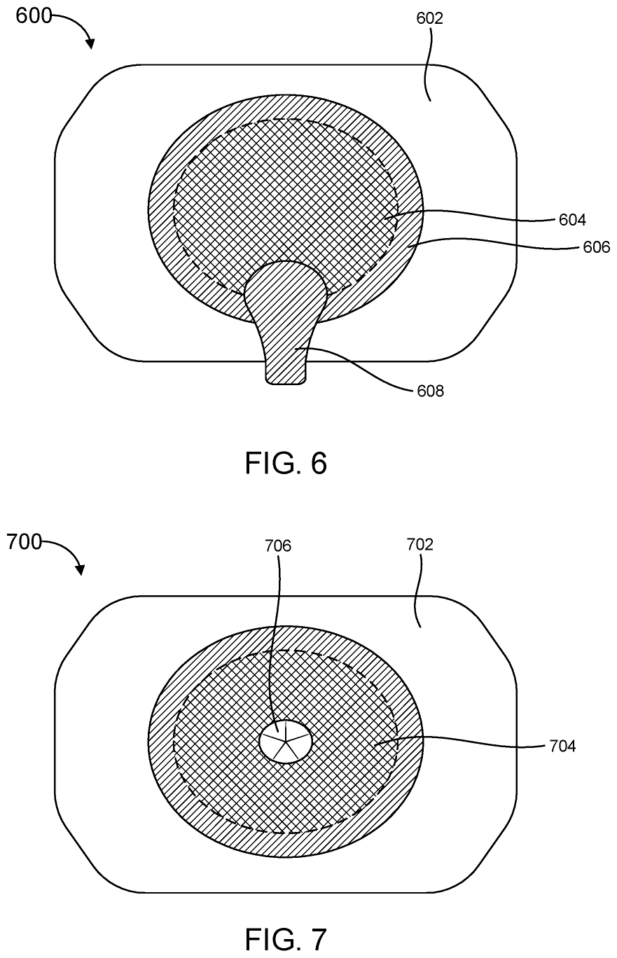

FIG. 6 illustrates an example of a self-adhesive mask 600 having an opening tab 608, according to some aspects of the disclosed technology. In practice, opening tab 608 is configured to facilitate the formation of a gap between filter 604 and adhesive film 602, for example, so that the wearer may drink from a straw. Opening tab 608 may be removably fixed to filter 604, for example, so that tab 608 can be removed when not in use, and re-attached for the purpose of facilitating the creation of an opening (gap) between adhesive film 602 and filter 604.

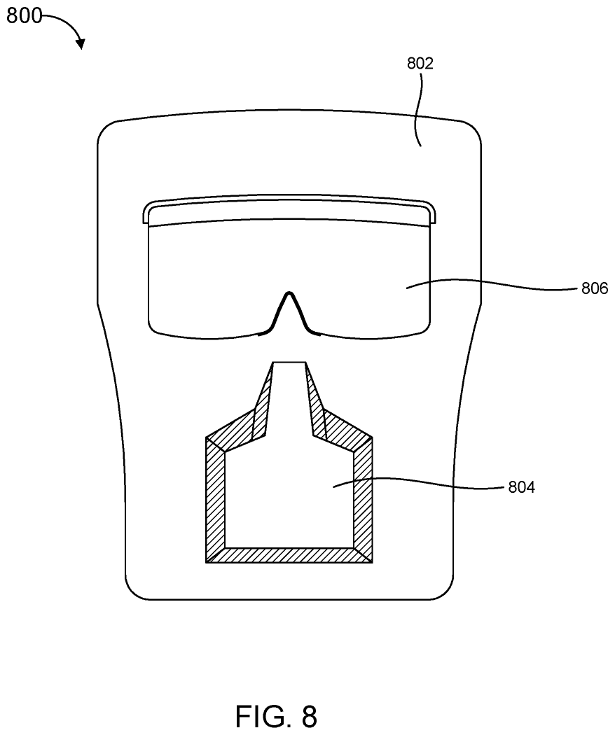

FIG. 7 illustrates an example of a self-adhesive mask 700 having a valve 706, according to some aspects of the disclosed technology. In the example of self-adhesive mask 700, valve 706 is disposed at a center location of filter 704. However, it is understood that valve 706 may be placed at different locations within filter 704, without departing from the scope of the disclosed technology.

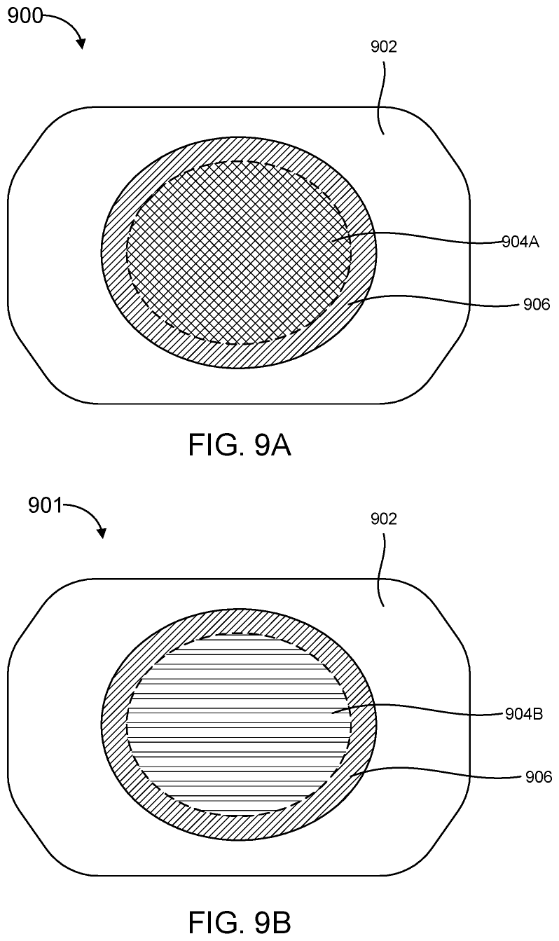

FIG. 8 illustrates an example of a full-face self-adhesive mask 800, according to some aspects of the disclosed technology. Mask 800 includes an adhesive film 802, that has a filter 804. Additionally, mask 800 includes a protective eye cover 806 that is configured to protect the wearer's eyes from exposure to bacteria and viruses. As understood by those of skill in the art, the material composition of adhesive film 802, filter 804, and/or eye cover 806, may vary depending on the desired implementation. For example, eye cover 806 may be comprised of a clear plastic or acrylic material.

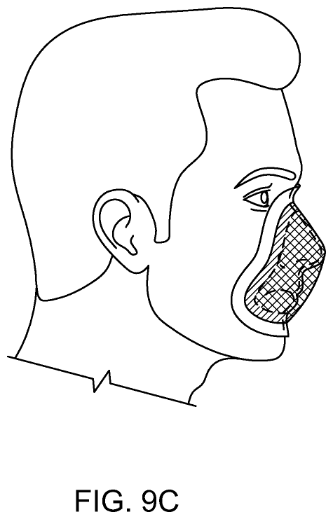

FIGS. 9A and 9B illustrate examples of self-adhesive masks with different filter patterns, according to some aspects of the disclosed technology. In the example of FIG. 9A, mask 900 is shown to have a crisscross filter pattern 904A, whereas in the example of FIG. 9B, mask 901 is shown to have a folded filter pattern 904B. It is understood that various filter pattern types may be implemented without departing from the scope of the disclosed technology.

FIG. 9C illustrates an example perspective view of a mask disposed on a wearer's face, according to some aspects of the disclosed technology. As illustrated in the example of FIG. 9C, the mask is pliable and can take on a three-dimensional shape necessary to form a comfortable and effective seal with the wearers face. In some aspects, the filtering material may be made intentionally firm, for example, to permit gaps/spaces between the wearer's mouth/nose and the filtering material.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A strapless protective mask comprising:
an adhesive film comprising an outer surface, an inner surface, and a central opening;
a filtering material affixed to the adhesive film, wherein the filtering material is configured to cover the central opening; and
a liner attached to the inner surface of the adhesive film, wherein the liner is configured to be removed to expose an adhesive layer on the inner surface of the adhesive film.

2. The strapless protective mask of claim 1, wherein the filtering material is configured to be removed from the adhesive film.

3. The strapless protective mask of claim 1, wherein at least a portion of the filtering material is affixed to the adhesive film using a removable tape.

4. The strapless protective mask of claim 1, wherein the filtering material is affixed to the inner surface of the adhesive film.

5. The strapless protective mask of claim 1, wherein the filtering material is affixed to the outer surface of the adhesive film.

6. The strapless protective mask of claim 1, wherein the filtering material is affixed to the adhesive film using a heat or melting process.

7. The strapless protective mask of claim 1, wherein the adhesive film comprises a polyurethane material.

8. The strapless protective mask of claim 1, wherein the adhesive film comprises an acrylic adhesive.

9. The strapless protective mask of claim 1, wherein the filtering material is configured to inhibit passage of bacteria or viruses.

10. The strapless protective mask of claim 1, wherein a carrier is affixed to the outer surface of the adhesive film, and wherein the carrier is comprised of a rigid material that is configured to maintain a shape of the adhesive film.

11. A method of forming a strapless protective mask, the method comprising:
cutting a central opening into an adhesive film, wherein the adhesive film comprises an outer surface and an inner surface;
affixing a filtering material to the adhesive film, wherein the filtering material is configured to cover the central opening; and
attaching a liner to the inner surface of the adhesive film, wherein the liner is configured to be removed to expose an adhesive layer on the inner surface of the adhesive film.

12. The method of claim 11, wherein the filtering material is configured to be removed from the adhesive film.

13. The method of claim 11, wherein at least a portion of the filtering material is affixed to the adhesive film using a removable tape.

14. The method of claim 11, wherein the filtering material is affixed to the inner surface of the adhesive film.

15. The method of claim 11, wherein the filtering material is affixed to the outer surface of the adhesive film.

16. The method of claim 11, wherein the filtering material is affixed to the adhesive film using a heat or melting process.

17. The method of claim 11, wherein the adhesive film comprises a polyurethane material.

18. The method of claim 11, wherein the adhesive film comprises an acrylic adhesive.

19. The method of claim 11, wherein the filtering material is configured to inhibit passage of bacteria or viruses.

20. The method of claim 11, wherein a carrier is affixed to the outer surface of the adhesive film, and wherein the carrier is comprised of a rigid material that is configured to maintain a shape of the adhesive film.
